(19) United States
(12) Patent Application Publication
(10) Pub. No.: US 2020/0374263 A1
(43) Pub. Date: Nov. 26, 2020

(54) LOCAL BREAKOUT SERVICE IN WIRELESS COMMUNICATION SYSTEMS

(71) Applicant: AT&T Intellectual Property I, L.P., Atlanta, GA (US)

(72) Inventors: Milap Majmundar, Austin, TX (US); Salam Akoum, Austin, TX (US); Xiaoyi Wang, Austin, TX (US); Thomas Novlan, Cedar Park, TX (US)

(21) Appl. No.: 16/419,584

(22) Filed: May 22, 2019

(51) Int. Cl. H04L 29/12; H04W 84/12

(52) U.S. Cl. CPC H04L 61/2007; H04W 88/02; H04W 84/12

(57) ABSTRACT

The described technology is generally directed towards using a local manager that serves a local radio access network (RAN) to provide one or more local breakout services between user equipments in the RAN, e.g., in 5G NR based networks. A local manager (e.g., a promoted UE) manages allocated resources for sidelink communication between two or more other UEs, by which the local manager can provide local breakout services either directly by serving as a router (and possibly an application server), or as an intermediate node by providing access to a locally hosted private network. In this way, private services can be provided to closed local RAN deployments. The local manager or private network can allocate IP addresses, and can host local virtual application server(s) as part of providing the local breakout services.

### TECHNICAL FIELD

The subject application is related to wireless communication systems, and, for example, to providing local breakout services via a local manager that serves user equipments in a local radio access network.

### BACKGROUND

In wireless communication systems, including New Radio (NR, sometimes referred to as 5G) and likely beyond, mobile networks will be deployed using a split radio access network (RAN) protocol architecture that has a centralized unit (CU) and a distributed unit (DU). User plane data is carried on Data Radio Bearers (DRBs) that traverse the user plane RAN protocol architecture. On the control plane, signaling radio bearers (SRBs) carry control messages. Each network user can be allocated multiple DRBs and SRBs by the network. The network interface between the CU and DU is called the F1 interface per 3GPP specifications.

3GPP also defines Integrated Access and Backhaul (IAB), in which user access and backhaul links are integrated with each other, to enable future cellular network deployment scenarios and applications. In general, an IAB node (relay node) can multiplex access and backhaul links in time, frequency, or space (e.g. beam-based operation).

Further, 3GPP NR supports direct peer-to-peer communications using the sidelink interface/sidelink channels. Peer-to-peer communications can be used to support use cases such as vehicle-to-everything (V2X) communication and local control in Industrial Internet-of-Things (IIoT) settings, such as automated factories. In such use cases, the traffic carried over Sidelink does not need access to a public RAN or a core network (e.g. the Regular RAN) to forward and process the traffic. Instead, such traffic is confined to a localized area (e.g. the Local RAN), using broadcast, multicast, and direct communication (unicast) between authorized devices.

In various aspects, a local manager provides resource allocation, user association, and local routing functionality over sidelink, which does not require full user equipment to network device (Uu) interface capabilities. For example, a local manager can be a mobile access point (e.g., a mobile IAB node) or a reasonably high-capability user equipment that is preconfigured or selected by the network to manage resources and devices associated with a local RAN. In one example of local RAN communications, a local manager is configured by a regular RAN (e.g. using LTE or NR control signaling on frequency range FR1), while the local data traffic and control signaling is exchanged between devices and the local manager over sidelink, potentially on different spectrum (e.g. using mmWave FR2 bands).

### BRIEF DESCRIPTION OF THE DRAWINGS

The technology described herein is illustrated by way of example and not limited in the accompanying figures in which like reference numerals indicate similar elements and in which:

FIG. 1 illustrates an example wireless communication system in which a radio access network (RAN) can be coupled to a local RAN via a local manager, and in which the local manager can route internet protocol packets between user equipments via sidelink channels, in accordance with various aspects and implementations of the subject disclosure.

FIG. 2 illustrates a local manager operating as a router that routes internet protocol packets between user equipments via sidelink channels, in accordance with various aspects and implementations of the subject disclosure.

FIG. 3 illustrates a RAN protocol stack for a local manager operating as a router, in accordance with various aspects and implementations of the subject disclosure.

FIG. 4 illustrates a local manager operating as an intermediate node to a private network for user plane traffic, in accordance with various aspects and implementations of the subject disclosure.

FIG. 5 illustrates a RAN protocol stack for a local manager operating as an intermediate node, in accordance with various aspects and implementations of the subject disclosure.

FIG. 6 illustrates a local manager operating as an intermediate node, coupled via an integrated access and backhaul node(s) to a private network for user plane traffic, in accordance with various aspects and implementations of the subject disclosure.

FIG. 7 illustrates a local manager that provides local breakout service to a user equipment, including by communicating IP packet data to a user plane function, in accordance with various aspects and implementations of the subject disclosure.

FIG. 8 illustrates example operations of a local manager that provides local breakout service by routing IP packet data between user equipments, in accordance with various aspects and implementations of the subject disclosure.

FIG. 9 illustrates example operations of a local manager that provides local breakout service by operating as an intermediate node to a private network, in accordance with various aspects and implementations of the subject disclosure.

FIG. 10 illustrates an example block diagram of an example mobile handset operable to engage in a system architecture that facilitates wireless communications according to one or more embodiments described herein.

FIG. 11 illustrates an example block diagram of an example computer operable to engage in a system architecture that facilitates wireless communications according to one or more embodiments described herein.

### DETAILED DESCRIPTION

Briefly, one or more aspects of the technology described herein are generally directed towards using a local manager device to provide local breakout service to user equipments in the local RAN area served by the local manager device. In general, the local manager device facilitates the communication of internet protocol (IP) data packets to and from at least one user equipment.

In one aspect, the local manager device provides a local breakout service by operating as a router of internet protocol (IP) data packets between two or more user equipments. More particularly, as described herein the local manager can directly provide local breakout service by receiving IP packets over a sidelink channel from one user equipment in the local RAN area and routing the IP packets for transmission via another sidelink channel to one or more UEs in the local RAN, and vice-versa. In this way, the local manager serves as a router for the local breakout packets.

In another aspect, the local manager device operates as an intermediate node (an anchor node) that connects one or more user equipments from the local RAN area to a local private network. Note that this is a local breakout service when the private network can be hosted locally. As one example, in a factory automation scenario, the local manager can be a locally deployed user equipment device, with a private donor distributed unit, private centralized unit and private user plane function locally hosted within the factory premises.

One or more embodiments are now described with reference to the drawings, wherein like reference numerals are used to refer to like elements throughout. In the following description, for purposes of explanation, numerous specific details are set forth in order to provide a thorough understanding of the various embodiments. It is evident, however, that the various embodiments can be practiced without these specific details (and without applying to any particular networked environment or standard).

As used in this disclosure, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component.

One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software application or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable (or machine-readable) device or computer-readable (or machine-readable) storage/communications media. For example, computer readable storage media can comprise, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

Moreover, terms such as “mobile device equipment,” “mobile station,” “mobile,” subscriber station,” “access terminal,” “terminal,” “handset,” “communication device,” “mobile device” (and/or terms representing similar terminology) can refer to a wireless device utilized by a subscriber or mobile device of a wireless communication service to receive or convey data, control, voice, video, sound, gaming or substantially any data-stream or signaling-stream. The foregoing terms are utilized interchangeably herein and with reference to the related drawings. Likewise, the terms “access point (AP),” “Base Station (BS),” BS transceiver, BS device, cell site, cell site device, “gNode B (gNB),” “evolved Node B (eNode B),” “home Node B (HNB)” and the like, are utilized interchangeably in the application, and refer to a wireless network component or appliance that transmits and/or receives data, control, voice, video, sound, gaming or substantially any data-stream or signaling-stream from one or more subscriber stations. Data and signaling streams can be packetized or frame-based flows.

Furthermore, the terms “device,” “communication device,” “mobile device,” “subscriber,” “customer entity,” “consumer,” “customer entity,” “entity” and the like are employed interchangeably throughout, unless context warrants particular distinctions among the terms. It should be appreciated that such terms can refer to human entities or automated components supported through artificial intelligence (e.g., a capacity to make inference based on complex mathematical formalisms), which can provide simulated vision, sound recognition and so forth.

Embodiments described herein can be exploited in substantially any wireless communication technology, comprising, but not limited to, wireless fidelity (Wi-Fi), global system for mobile communications (GSM), universal mobile telecommunications system (UMTS), worldwide interoperability for microwave access (WiMAX), enhanced general packet radio service (enhanced GPRS), third generation partnership project (3GPP) long term evolution (LTE), third generation partnership project 2 (3GPP2) ultra mobile broadband (UMB), high speed packet access (HSPA), Z-Wave, Zigbee and other 802.XX wireless technologies and/or legacy telecommunication technologies.

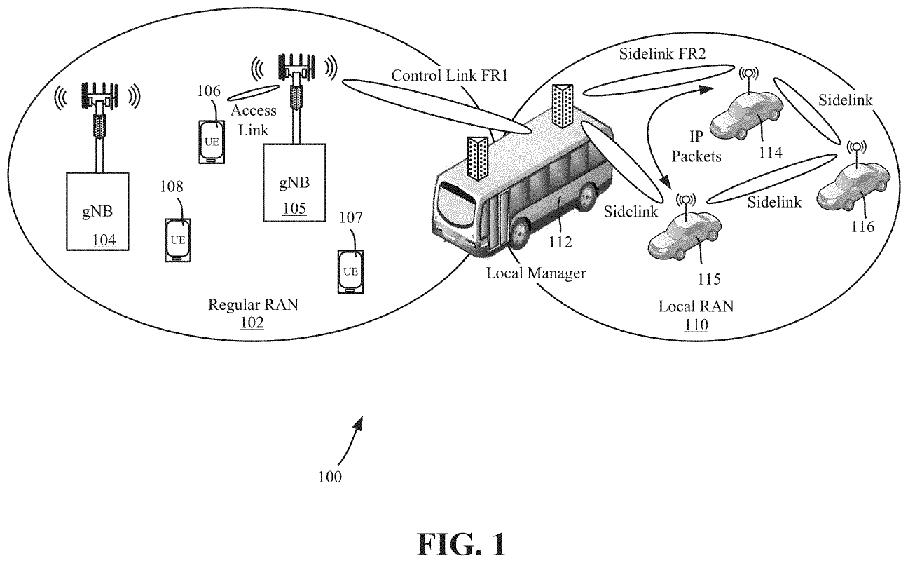

Referring now to FIG. 1, illustrated is an example wireless communication system 100 in accordance with various aspects and embodiments of the subject disclosure. In one or more embodiments, system 100 can comprise a “regular” radio access network 102, that is, one conventionally understood as having some number of gNodeBs (gNBs 104 and 105 are illustrated in FIG. 1, however as is understood, there can be any practical number of such network nodes in a given radio access network). User equipments (UEs) 106-108 are shown as present in the RAN 102, e.g., the user equipment 106 communicates with the gNodeB 105 over an access link.

FIG. 1 also illustrates an example of local RAN 110 and communications therein, in which a local manager 112 is configured by the regular RAN 102 (as depicted by the control link, e.g. using LTE or NR control signaling on FR1). In FIG. 1, in the local RAN 110, the local data traffic and control signaling is exchanged between devices 114-116 (e.g., represented as vehicles in FIG. 1, however any user equipment devices such as IoT sensors and the like can be substituted for the exemplified vehicles) and the local manager 112 over sidelink channels (and interfaces), potentially on different spectrum (e.g. mmWave FR2 bands). In some scenarios, the user equipment (UE) access and association can be managed by the regular RAN 102 and relayed through the local manager 112, because both the regular RAN 102 and local RAN 110 can be considered as part of the public network deployment using licensed operator spectrum.

Notwithstanding the ability of public network deployment, as described herein, certain use cases for V2X/IIoT use cases may use private and localized communication, in which control and user plane traffic is not to be shared outside of the local RAN 110. The technology described herein provides a framework such that the user equipment (UE) can engage in local breakout communication facilitated by a local manager access point, without requiring connectivity to a public radio access network (RAN) or core network (CN). For example, in FIG. 1, the devices 114 and 115 are shown as having IP packets routed between each other via the local manager 112 using respective sidelink channels, without needing to go through the regular RAN 102.

Note that as used herein, the non-limiting term “user equipment” can refer to any type of device that can communicate with a network node in a cellular or mobile communication system. A UE can have one or more antenna panels having vertical and horizontal elements. Examples of a UE comprise a target device, device to device (D2D) UE, machine type UE or UE capable of machine to machine (M2M) communications, personal digital assistant (PDA), tablet, mobile terminals, smart phone, laptop mounted equipment (LME), universal serial bus (USB) dongles enabled for mobile communications, a computer having mobile capabilities, a mobile device such as cellular phone, a laptop having laptop embedded equipment (LEE, such as a mobile broadband adapter), a tablet computer having a mobile broadband adapter, a wearable device, a virtual reality (VR) device, a heads-up display (HUD) device, a smart car, a machine-type communication (MTC) device, and the like. User equipment UE 102 can also comprise IOT devices that communicate wirelessly.

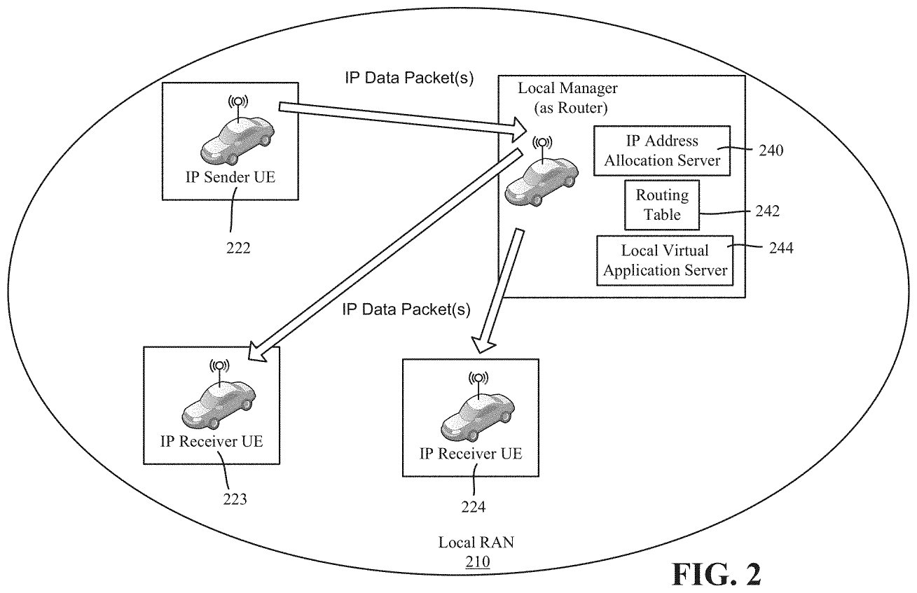

FIG. 2 shows how a local manager 221 can directly provide local breakout service by receiving packets over a sidelink channel from one UE 222 (an IP packet sender in this example) in the local RAN area and routing them for transmission via another sidelink channel to one or more UEs (IP packet receivers) 223 and 224 in a local RAN served by the local manager 221. As can be readily appreciated, IP data packets can be routed via the local manager 221 to a single receiver rather than to multiple receivers, and a receiver can become a sender and send IP data packets via the local manager 221 to one or more other user equipments in the local RAN 210. Thus, the local manager 221 serves as a router for the local breakout packets.

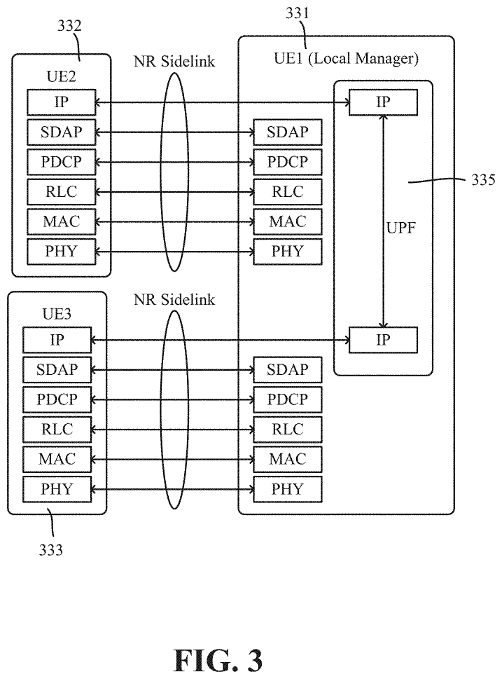

An example RAN protocol stack for accomplishing such local breakout service with a local manager 331 operating (in part) as a router are provided in FIG. 3. More particularly, FIG. 3 shows UE1 acting as the local manager 331 providing local breakout service between UE2 (labeled 332) and UE3 (labeled 333) via sidelink channel communications. For UE2 332, the local manager 331 terminates the full sidelink protocol stack, and provides an IP routing functionality via a local User Plane Function (UPF) 335 to the IP address of UE3 333 with whom it communicates via a second sidelink channel.

The local manager 331 can provide various local breakout services, including (but not limited to) providing local breakout service between two UEs as in FIG. 3, as well as between multiple UEs (as in FIG. 2) by routing the data packets using IP addressing. Returning to FIG. 2, the exemplified local manager 221 can serve as an IP address allocation server (block 240), e.g., by dynamically allocating IP addresses to UEs in the local RAN area for each individual sidelink channel.

Further, the local manager 221 can maintain a routing table 242 that maps allocated IP addresses to individual UE sidelink channels, whereby the local manager 221 can appropriately route packets from any one UE to any other UE in the local RAN area via the appropriate sidelink channel. As is understood, as represented in FIG. 2, the local manager 221 can provide IP Multicast service to some or all the UEs to which the local manager 221 is connected via a sidelink channel in order to broadcast/multicast packets received from one or more UEs in the local RAN area 210.

Still further, the local manager 221 can host a local virtual application server 244 in order to provide application layer local breakout services. For example, the virtual application server could host a gaming or augmented reality/virtual reality service that interacts with multiple UEs in the local RAN area via sidelink channels.

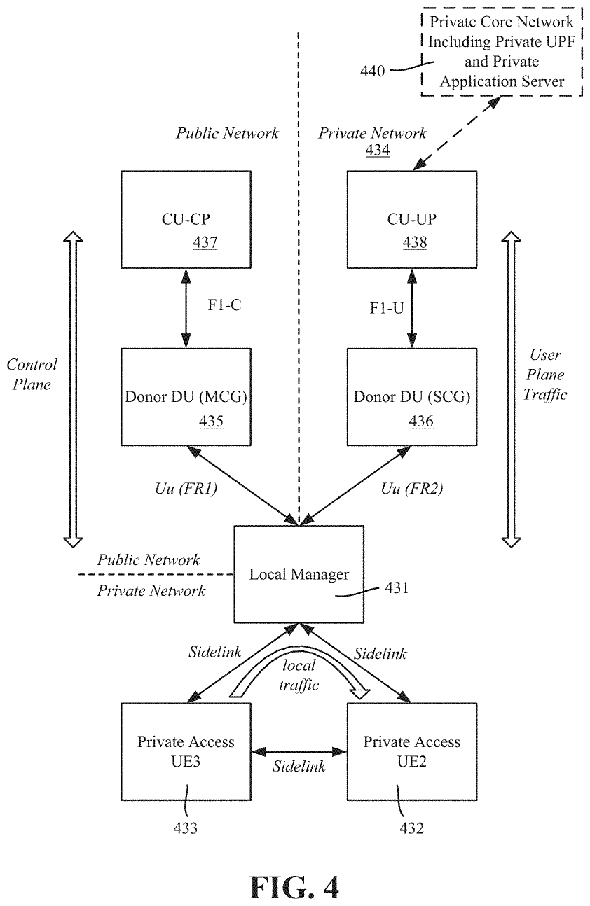

Turning to another aspect, as generally represented in FIG. 4, a local manager 431 can operate as an intermediate node that provides a local breakout service. In general, this is based on the local manager 431 being able to serve as an anchor node that connects UEs from a local RAN area served by the local manager 431 to a local private network.

FIG. 4 thus shows the local manager 431 providing access to a private network for user plane functionality. More particularly, the local manager 431 provides private access UEs 432 and 433 with access to a private network 434 for user plane traffic (the right side of the dashed vertical line). Thus, in the upper right side of FIG. 4, the local manager 431 attaches to a private donor distributed unit (DU) 436, which serves as a secondary cell group (SCG) connecting to a centralized unit-user plane (CU-UP) 438, as well as potentially a private core network 440, which can include a private UPF and possibly a private application server. Thus, the private network can host one or more local private application server to provide private application services to the private UEs, and possibly to the local manager 431.

Note that unlike acting as a router, in the embodiment illustrated in FIG. 4, the local manager 431 serves as an intermediate node to pass packets from the private access UEs 433 and/or 434 to the donor DU 436 to the CU-UP 438 and UPF (part of block 440). This can still be considered a local breakout service, because the private network can be hosted locally. For example, in a factory automation scenario, the local manager 431 can be a locally deployed UE, and the donor DU 436, CU-UP 438 and UPF can be locally hosted within the factory premises.

Note further that the technology described herein can provide the same types of local breakout services as described with reference to FIG. 2, except that the UPF and application server(s) (part of block 440) are located outside the local manager 431 and instead are hosted locally within the private network 434. Although not explicitly shown in FIGS. 4-6, the private network can provide IP address allocation functionality to the private user equipments.

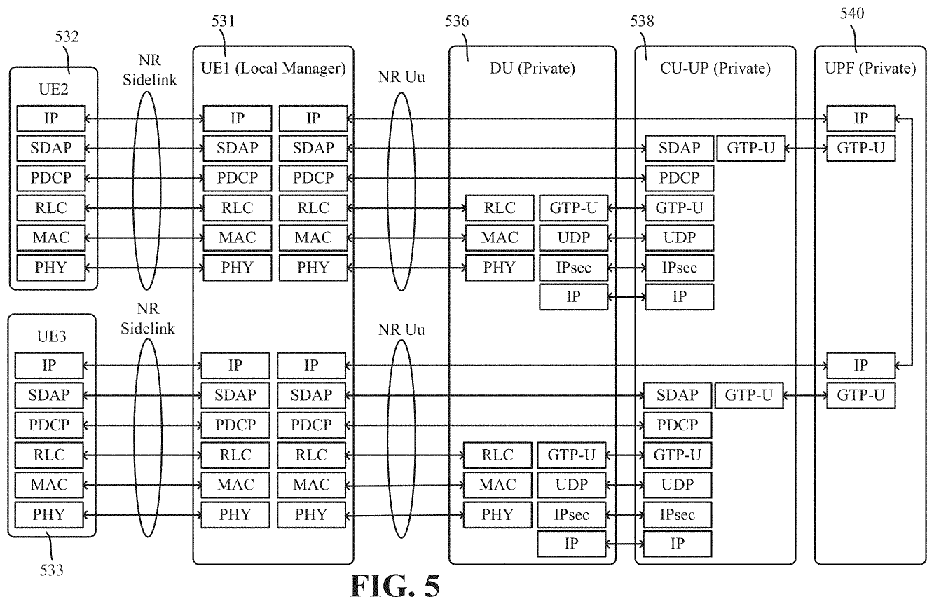

An example of the RAN protocol stack details for such a locally hosted private network service are shown in FIG. 5, including the RAN Protocol Stack for a local manager 531 (UE1) operating as an intermediate node. In FIG. 5, the local manager 531 (UE1) communicates with both UE2 532 and UE3 533 via NR sidelink. In this scenario the local manager 531 acts mainly as an intermediate node, passing on traffic from a transmitting UE (for example, UE 532/UE2) to the private DU 536, private CU-UP 538 and private UPF 540 that reside locally in the private network.

As also shown in FIG. 5, the UPF 540 can further perform the routing of packets from UE2 532 to the IP address corresponding to UE3 533, which is passed on through the same private CU-UP 538, private DU 536, and local manager 531 (UE1) on a different (downlink) bearer of the local manager 531. From the perspective of the DU 536 and the CU-UP 538, the local manager 531 (UE1) appears as just a normal UE communicating with the private network on one uplink bearer and one downlink bearer. To the private UEs 532 and 533 (UE2 and UE3), the private network is not visible, as these UEs in general only communicate with the local manager 531 via sidelink. Only the local manager 531 is aware of both sides, acting as an intermediate node to enable the local breakout via a locally resident private network.

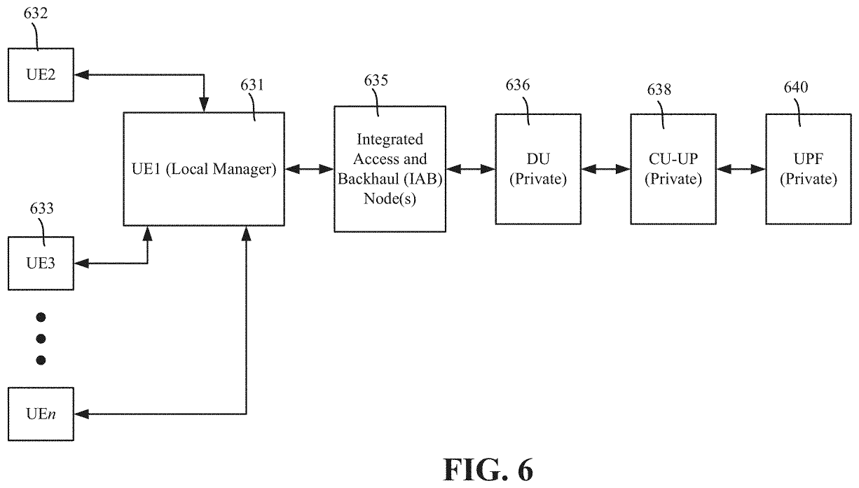

Note that in FIG. 5, the local manager 531 is shown as attached to the private DU 536 as a normal UE. Hence, for the local manager 531, the DU 536 is the access node. However, in an alternative implementation such as represented in FIG. 6, it is possible that within the private network one or more additional private IAB nodes 635 are deployed. In such an alternative implementation, the local manager 631 can associate to an access IAB node 635, which then connects via a multi-hop IAB network to a donor DU 636 and then to the CU-UP 638. The above local breakout service functionality can be otherwise identical in such an implementation, with the change being that the local breakout traffic from the local manager 631 goes through a multi-hop IAB network to reach the UPF 640, and vice versa.

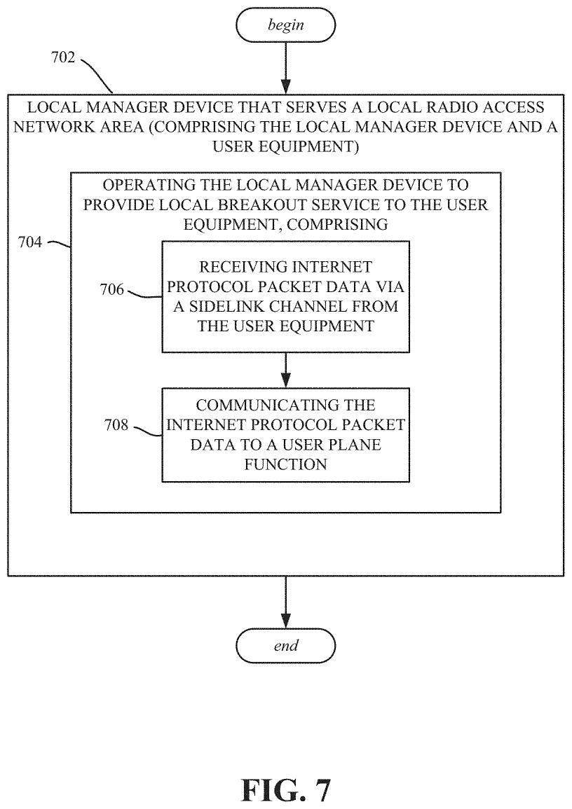

One or more example aspects are represented in FIG. 7, and can correspond to a local manager device (block 702) that serves a local radio access network area comprising the local manager device and a user equipment. The local manager device can comprise a processor, and a memory that stores executable instructions that, when executed by the processor, facilitate performance of operations. Example operation 704 represents operating the local manager device to provide local breakout service to the user equipment, comprising receiving internet protocol packet data via a sidelink channel from the user equipment (operation 706), and communicating the internet protocol packet data to a user plane function (operation 708).

Further operations can comprise allocating an internet protocol address to the user equipment, and associating the internet protocol address to the sidelink channel.

The user plane function can be incorporated into the local manager device, the user equipment can be a first user equipment, and the sidelink channel can be a first sidelink channel; further operations can comprise facilitating routing the internet protocol packet data from the user plane function to a second user equipment over a second sidelink channel.

Further operations can comprise maintaining a routing data structure that maps allocated internet protocol addresses to respective user equipment sidelink channels, and accessing the routing data structure based on internet protocol information associated with the internet protocol packet data to determine the second sidelink channel.

The user plane function can be incorporated into the local manager device, the user equipment can be a first user equipment, and the sidelink channel can be a first sidelink channel; further operations can comprise multicasting the internet protocol packet data from the user plane function to a second user equipment via a second sidelink channel and to a third user equipment via a third sidelink channel.

The local breakout service can comprise a first local breakout service for packet routing, and further operations can comprise providing a second local breakout service, comprising hosting a local virtual application server to provide an application layer local breakout service as the second local breakout service.

The user equipment can comprise a private access user equipment, the user plane function can be a private user plane function incorporated into a local private network comprising a locally hosted donor distributed unit communicatively coupled via private user plane traffic to a centralized unit and the private user plane function, and operating the local manager device to provide the local breakout service to the user equipment can comprise operating the local manager device as an intermediate node to communicate the internet protocol data packet from the private access user equipment to the private user plane function.

The internet protocol packet data can comprise a first internet protocol packet data, the local private network can host an application server, and further operations can comprise communicating a second internet protocol packet data from the application server to the user equipment.

The local manager device can be communicatively coupled to the private user plane function via a private donor distributed unit and a private centralized unit. The local manager device can be communicatively coupled to the private user plane function via an internet access and backhaul node.

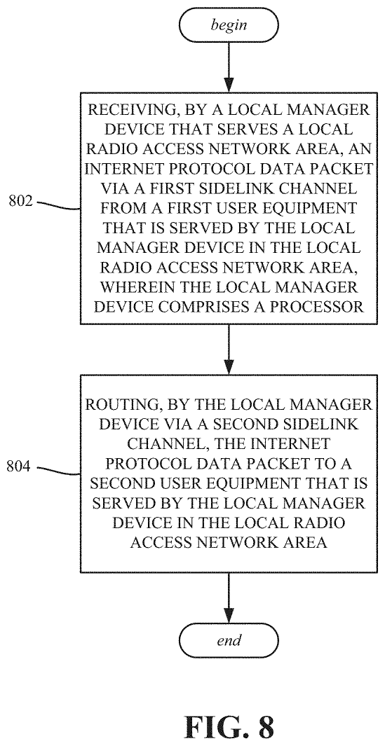

One or more aspects, such as those implemented in example operations (e.g., performed by a local manager device comprising a processor) of a method, are represented in FIG. 8, and are directed towards receiving (operation 802), by a local manager device that serves a local radio access network area, an internet protocol data packet via a first sidelink channel from a first user equipment that is served by the local manager device in the local radio access network area. Operation 804 represents routing, by the local manager device via a second sidelink channel, the internet protocol data packet to a second user equipment that is served by the local manager device in the local radio access network area.

The local manager device can perform the routing via a user plane function in the local manager device.

Aspects can comprise allocating, by the local manager device, a first internet protocol address to the first user equipment, and allocating, by the local manager device, a second internet protocol address to the second user equipment

Aspects can comprise maintaining, by the local manager device, a first mapping from a first internet protocol address to the first sidelink channel, and maintaining, by the local manager device, a second mapping from the second internet protocol address to the second sidelink channel.

Aspects can comprise, routing, by the local manager device via a third sidelink channel, the internet protocol data packet to a third user equipment that is served by the local manager device in the local radio access network area.

Aspects can comprise hosting, by the local manager device, a local virtual application server that provides an application layer local breakout service to the first user equipment via the first sidelink channel.

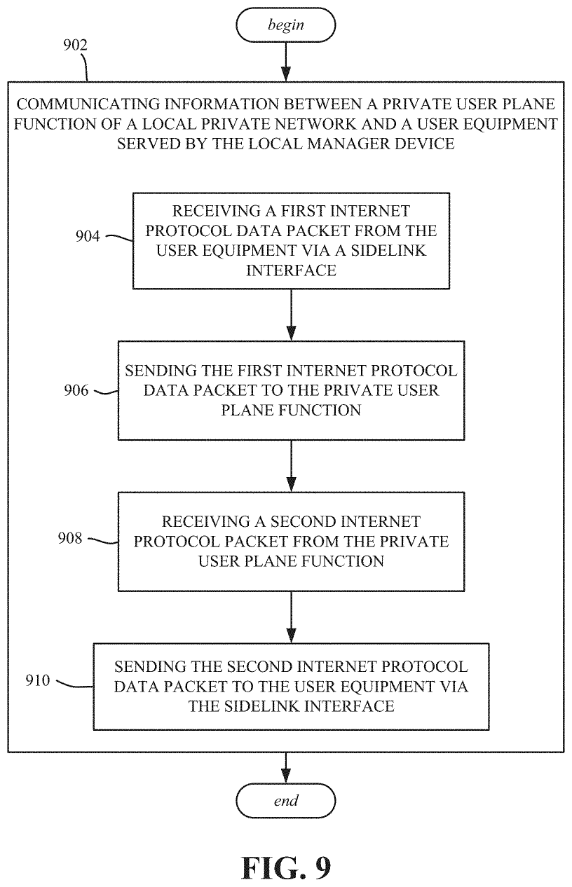

One or more aspects, such as implemented in a machine-readable storage medium, comprising executable instructions that, when executed by a processor of a local manager device, facilitate performance of example operations, are represented in FIG. 9. Operation 902 represents communicating information between a private user plane function of a local private network and a user equipment served by the local manager device. Operation 904 represents receiving a first internet protocol data packet from the user equipment via a sidelink interface. Operation 906 represents sending the first internet protocol data packet to the private user plane function. Operation 908 represents receiving a second internet protocol packet from the private user plane function. Operation 910 represents sending the second internet protocol data packet to the user equipment via the sidelink interface.

Sending the first internet protocol data packet to the private user plane function can comprise transmitting the first internet protocol data packet via a private distributed unit coupled to a private centralized unit to the private user plane function.

Further operations can comprise associating the local manager device with an integrated access and backhaul node that is communicatively coupled to the private distributed unit.

The private network hosts an application server; further operations can comprise, receiving a third internet protocol packet from the application server, and sending the third internet protocol data packet to the user equipment via the sidelink interface.

As can be seen, the technology described herein enables local breakout services between UEs, including in 5G NR based networks. When a UE has been promoted to a local manager that manages allocated resources for sidelink communication between two other UEs, the local manager can provide local breakout services either directly by serving as a router and application server, or as an intermediate node by providing access to a locally hosted private network. The technology described herein supports providing local breakout services in a local RAN area served by a local manager. The technology described herein enables a local manager to independently serve as an agent that provides local breakout services between different UEs in a local RAN area. The technology described herein enables a local manager to provide local breakout services via a locally hosted private network by serving as an intermediate node. This can be very useful in scenarios such as providing private services to closed local RAN deployments, such as for factory automation use cases and the like, for example to enable sensor data sharing between UEs within the local RAN, support automation-related traffic (such as control signals between machines), and point-to-point communication messages between two or more local UEs.

A wireless communication system can employ various cellular systems, technologies, and modulation schemes to facilitate wireless radio communications between devices (e.g., a UE and the network device). While example embodiments might be described for 5G new radio (NR) systems, the embodiments can be applicable to any radio access technology (RAT) or multi-RAT system where the UE operates using multiple carriers e.g. LTE FDD/TDD, GSM/GERAN, CDMA2000 etc. For example, the system can operate in accordance with global system for mobile communications (GSM), universal mobile telecommunications service (UMTS), long term evolution (LTE), LTE frequency division duplexing (LTE FDD, LTE time division duplexing (TDD), high speed packet access (HSPA), code division multiple access (CDMA), wideband CDMA (WCMDA), CDMA2000, time division multiple access (TDMA), frequency division multiple access (FDMA), multi-carrier code division multiple access (MC-CDMA), single-carrier code division multiple access (SC-CDMA), single-carrier FDMA (SC-FDMA), orthogonal frequency division multiplexing (OFDM), discrete Fourier transform spread OFDM (DFT-spread OFDM) single carrier FDMA (SC-FDMA), Filter bank based multi-carrier (FBMC), zero tail DFT-spread-OFDM (ZT DFT-s-OFDM), generalized frequency division multiplexing (GFDM), fixed mobile convergence (FMC), universal fixed mobile convergence (UFMC), unique word OFDM (UW-OFDM), unique word DFT-spread OFDM (UW DFT-Spread-OFDM), cyclic prefix OFDM CP-OFDM, resource-block-filtered OFDM, Wi Fi, WLAN, WiMax, and the like. However, various features and functionalities of system are particularly described wherein the devices (e.g., the UEs and the network device) of the system are configured to communicate wireless signals using one or more multi carrier modulation schemes, wherein data symbols can be transmitted simultaneously over multiple frequency subcarriers (e.g., OFDM, CP-OFDM, DFT-spread OFDM, UFMC, FMBC, etc.). The embodiments are applicable to single carrier as well as to multicarrier (MC) or carrier aggregation (CA) operation of the UE. The term carrier aggregation (CA) is also called (e.g. interchangeably called) “multi-carrier system”, “multi-cell operation”, “multi-carrier operation”, “multi-carrier” transmission and/or reception. Note that some embodiments are also applicable for Multi RAB (radio bearers) on some carriers (that is data plus speech is simultaneously scheduled).

In various embodiments, the system can be configured to provide and employ 5G wireless networking features and functionalities. With 5G networks that may use waveforms that split the bandwidth into several sub-bands, different types of services can be accommodated in different sub-bands with the most suitable waveform and numerology, leading to improved spectrum utilization for 5G networks. Notwithstanding, in the mmWave spectrum, the millimeter waves have shorter wavelengths relative to other communications waves, whereby mmWave signals can experience severe path loss, penetration loss, and fading. However, the shorter wavelength at mmWave frequencies also allows more antennas to be packed in the same physical dimension, which allows for large-scale spatial multiplexing and highly directional beamforming.

Performance can be improved if both the transmitter and the receiver are equipped with multiple antennas. Multi-antenna techniques can significantly increase the data rates and reliability of a wireless communication system. The use of multiple input multiple output (MIMO) techniques, which was introduced in the third-generation partnership project (3GPP) and has been in use (including with LTE), is a multi-antenna technique that can improve the spectral efficiency of transmissions, thereby significantly boosting the overall data carrying capacity of wireless systems. The use of multiple-input multiple-output (MIMO) techniques can improve mmWave communications; MIMO can be used for achieving diversity gain, spatial multiplexing gain and beamforming gain.

Note that using multi-antennas does not always mean that MIMO is being used. For example, a configuration can have two downlink antennas, and these two antennas can be used in various ways. In addition to using the antennas in a 2×2 MIMO scheme, the two antennas can also be used in a diversity configuration rather than MIMO configuration. Even with multiple antennas, a particular scheme might only use one of the antennas (e.g., LTE specification's transmission mode 1, which uses a single transmission antenna and a single receive antenna). Or, only one antenna can be used, with various different multiplexing, precoding methods etc.

The MIMO technique uses a commonly known notation (M×N) to represent MIMO configuration in terms number of transmit (M) and receive antennas (N) on one end of the transmission system. The common MIMO configurations used for various technologies are: (2×1), (1×2), (2×2), (4×2), (8×2) and (2×4), (4×4), (8×4). The configurations represented by (2×1) and (1×2) are special cases of MIMO known as transmit diversity (or spatial diversity) and receive diversity. In addition to transmit diversity (or spatial diversity) and receive diversity, other techniques such as spatial multiplexing (comprising both open-loop and closed-loop), beamforming, and codebook-based precoding can also be used to address issues such as efficiency, interference, and range.

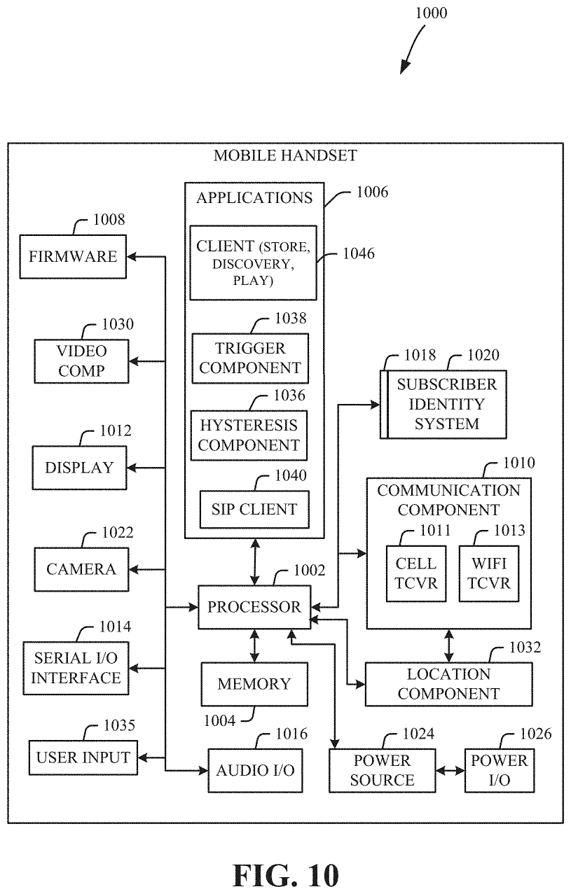

Referring now to FIG. 10, illustrated is a schematic block diagram of an example end-user device such as a user equipment) that can be a mobile device 1000 capable of connecting to a network in accordance with some embodiments described herein. Although a mobile handset 1000 is illustrated herein, it will be understood that other devices can be a mobile device, and that the mobile handset 1000 is merely illustrated to provide context for the embodiments of the various embodiments described herein. The following discussion is intended to provide a brief, general description of an example of a suitable environment 1000 in which the various embodiments can be implemented. While the description includes a general context of computer-executable instructions embodied on a machine-readable storage medium, those skilled in the art will recognize that the various embodiments also can be implemented in combination with other program modules and/or as a combination of hardware and software.

Generally, applications (e.g., program modules) can include routines, programs, components, data structures, etc., that perform particular tasks or implement particular abstract data types. Moreover, those skilled in the art will appreciate that the methods described herein can be practiced with other system configurations, including single-processor or multiprocessor systems, minicomputers, mainframe computers, as well as personal computers, hand-held computing devices, microprocessor-based or programmable consumer electronics, and the like, each of which can be operatively coupled to one or more associated devices.

A computing device can typically include a variety of machine-readable media. Machine-readable media can be any available media that can be accessed by the computer and includes both volatile and non-volatile media, removable and non-removable media. By way of example and not limitation, computer-readable media can comprise computer storage media and communication media. Computer storage media can include volatile and/or non-volatile media, removable and/or non-removable media implemented in any method or technology for storage of information, such as computer-readable instructions, data structures, program modules or other data. Computer storage media can include, but is not limited to, RAM, ROM, EEPROM, flash memory or other memory technology, CD ROM, digital video disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

The handset 1000 includes a processor 1002 for controlling and processing all onboard operations and functions. A memory 1004 interfaces to the processor 1002 for storage of data and one or more applications 1006 (e.g., a video player software, user feedback component software, etc.). Other applications can include voice recognition of predetermined voice commands that facilitate initiation of the user feedback signals. The applications 1006 can be stored in the memory 1004 and/or in a firmware 1008, and executed by the processor 1002 from either or both the memory 1004 or/and the firmware 1008. The firmware 1008 can also store startup code for execution in initializing the handset 1000. A communications component 1010 interfaces to the processor 1002 to facilitate wired/wireless communication with external systems, e.g., cellular networks, VoIP networks, and so on. Here, the communications component 1010 can also include a suitable cellular transceiver 1011 (e.g., a GSM transceiver) and/or an unlicensed transceiver 1013 (e.g., Wi-Fi, WiMax) for corresponding signal communications. The handset 1000 can be a device such as a cellular telephone, a PDA with mobile communications capabilities, and messaging-centric devices. The communications component 1010 also facilitates communications reception from terrestrial radio networks (e.g., broadcast), digital satellite radio networks, and Internet-based radio services networks.

The handset 1000 includes a display 1012 for displaying text, images, video, telephony functions (e.g., a Caller ID function), setup functions, and for user input. For example, the display 1012 can also be referred to as a “screen” that can accommodate the presentation of multimedia content (e.g., music metadata, messages, wallpaper, graphics, etc.). The display 1012 can also display videos and can facilitate the generation, editing and sharing of video quotes. A serial I/O interface 1014 is provided in communication with the processor 1002 to facilitate wired and/or wireless serial communications (e.g., USB, and/or IEEE 1394) through a hardwire connection, and other serial input devices (e.g., a keyboard, keypad, and mouse). This supports updating and troubleshooting the handset 1000, for example. Audio capabilities are provided with an audio I/O component 1016, which can include a speaker for the output of audio signals related to, for example, indication that the user pressed the proper key or key combination to initiate the user feedback signal. The audio I/O component 1016 also facilitates the input of audio signals through a microphone to record data and/or telephony voice data, and for inputting voice signals for telephone conversations.

The handset 1000 can include a slot interface 1018 for accommodating a SIC (Subscriber Identity Component) in the form factor of a card Subscriber Identity Module (SIM) or universal SIM 1020, and interfacing the SIM card 1020 with the processor 1002. However, it is to be appreciated that the SIM card 1020 can be manufactured into the handset 1000, and updated by downloading data and software.

The handset 1000 can process IP data traffic through the communication component 1010 to accommodate IP traffic from an IP network such as, for example, the Internet, a corporate intranet, a home network, a person area network, etc., through an ISP or broadband cable provider. Thus, VoIP traffic can be utilized by the handset 800 and IP-based multimedia content can be received in either an encoded or decoded format.

A video processing component 1022 (e.g., a camera) can be provided for decoding encoded multimedia content. The video processing component 1022 can aid in facilitating the generation, editing and sharing of video quotes. The handset 1000 also includes a power source 1024 in the form of batteries and/or an AC power subsystem, which power source 1024 can interface to an external power system or charging equipment (not shown) by a power I/O component 1026.

The handset 1000 can also include a video component 1030 for processing video content received and, for recording and transmitting video content. For example, the video component 1030 can facilitate the generation, editing and sharing of video quotes. A location tracking component 1032 facilitates geographically locating the handset 1000. As described hereinabove, this can occur when the user initiates the feedback signal automatically or manually. A user input component 1034 facilitates the user initiating the quality feedback signal. The user input component 1034 can also facilitate the generation, editing and sharing of video quotes. The user input component 1034 can include such conventional input device technologies such as a keypad, keyboard, mouse, stylus pen, and/or touch screen, for example.

Referring again to the applications 1006, a hysteresis component 1036 facilitates the analysis and processing of hysteresis data, which is utilized to determine when to associate with the access point. A software trigger component 1038 can be provided that facilitates triggering of the hysteresis component 1038 when the Wi-Fi transceiver 1013 detects the beacon of the access point. A SIP client 1040 enables the handset 1000 to support SIP protocols and register the subscriber with the SIP registrar server. The applications 1006 can also include a client 1042 that provides at least the capability of discovery, play and store of multimedia content, for example, music.

The handset 1000, as indicated above related to the communications component 810, includes an indoor network radio transceiver 1013 (e.g., Wi-Fi transceiver). This function supports the indoor radio link, such as IEEE 802.11, for the dual-mode GSM handset 1000. The handset 1000 can accommodate at least satellite radio services through a handset that can combine wireless voice and digital radio chipsets into a single handheld device.

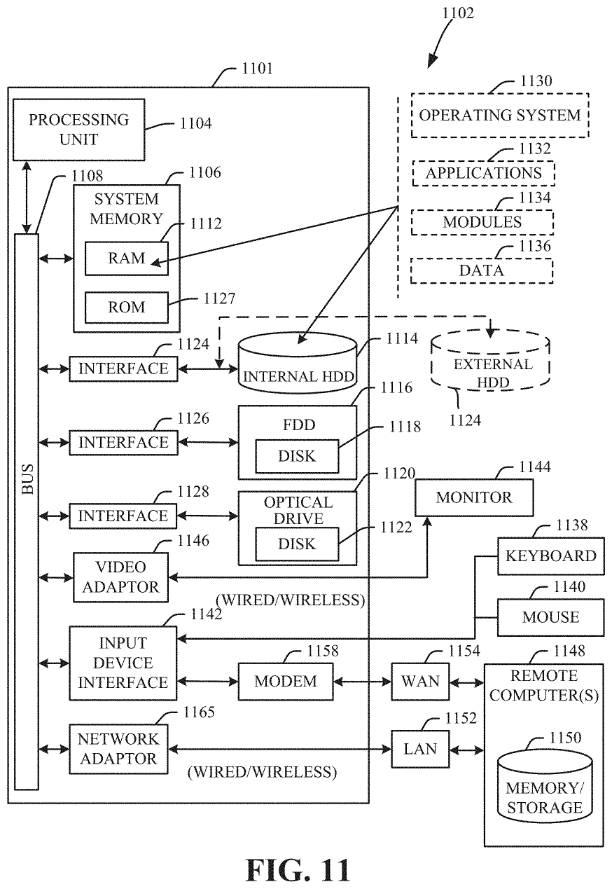

Referring now to FIG. 11, there is illustrated a block diagram of a computer 1100 operable to execute the functions and operations performed in the described example embodiments. For example, a network node (e.g., network node 116, GNB 202, etc.) may contain components as described in FIG. 11. The computer 1100 can provide networking and communication capabilities between a wired or wireless communication network and a server and/or communication device. In order to provide additional context for various aspects thereof, FIG. 1 and the following discussion are intended to provide a brief, general description of a suitable computing environment in which the various aspects of the embodiments can be implemented to facilitate the establishment of a transaction between an entity and a third party. While the description above is in the general context of computer-executable instructions that can run on one or more computers, those skilled in the art will recognize that the various embodiments also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the various methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the various embodiments can also be practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media or communications media, which two terms are used herein differently from one another as follows.

Computer-readable storage media can be any available storage media that can be accessed by the computer and includes both volatile and nonvolatile media, removable and non-removable media. By way of example, and not limitation, computer-readable storage media can be implemented in connection with any method or technology for storage of information such as computer-readable instructions, program modules, structured data, or unstructured data. Computer-readable storage media can include, but are not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or other tangible and/or non-transitory media which can be used to store desired information. Computer-readable storage media can be accessed by one or more local or remote computing devices, e.g., via access requests, queries or other data retrieval protocols, for a variety of operations with respect to the information stored by the medium.

Communications media can embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference to FIG. 11, implementing various aspects described herein with regards to the end-user device can include a computer 1100, the computer 1100 including a processing unit 1104, a system memory 1106 and a system bus 1108. The system bus 1108 couples system components including, but not limited to, the system memory 1106 to the processing unit 1104. The processing unit 1104 can be any of various commercially available processors. Dual microprocessors and other multi-processor architectures can also be employed as the processing unit 1104.

The system bus 1108 can be any of several types of bus structure that can further interconnect to a memory bus (with or without a memory controller), a peripheral bus, and a local bus using any of a variety of commercially available bus architectures. The system memory 1106 includes read-only memory (ROM) 1127 and random access memory (RAM) 1112. A basic input/output system (BIOS) is stored in a non-volatile memory 1127 such as ROM, EPROM, EEPROM, which BIOS contains the basic routines that help to transfer information between elements within the computer 1100, such as during start-up. The RAM 1112 can also include a high-speed RAM such as static RAM for caching data.

The computer 1100 further includes an internal hard disk drive (HDD) 1114 (e.g., EIDE, SATA), which internal hard disk drive 1114 can also be configured for external use in a suitable chassis (not shown), a magnetic floppy disk drive (FDD) 1116, (e.g., to read from or write to a removable diskette 1118) and an optical disk drive 1120, (e.g., reading a CD-ROM disk 1122 or, to read from or write to other high capacity optical media such as the DVD). The hard disk drive 1114, magnetic disk drive 1116 and optical disk drive 1120 can be connected to the system bus 1108 by a hard disk drive interface 1124, a magnetic disk drive interface 1126 and an optical drive interface 1128, respectively. The interface 1124 for external drive implementations includes at least one or both of Universal Serial Bus (USB) and IEEE 1394 interface technologies. Other external drive connection technologies are within contemplation of the subject embodiments.

The drives and their associated computer-readable media provide nonvolatile storage of data, data structures, computer-executable instructions, and so forth. For the computer 1100 the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer 1100, such as zip drives, magnetic cassettes, flash memory cards, cartridges, and the like, can also be used in the example operating environment, and further, that any such media can contain computer-executable instructions for performing the methods of the disclosed embodiments.

A number of program modules can be stored in the drives and RAM 1112, including an operating system 1130, one or more application programs 1132, other program modules 1134 and program data 1136. All or portions of the operating system, applications, modules, and/or data can also be cached in the RAM 1112. It is to be appreciated that the various embodiments can be implemented with various commercially available operating systems or combinations of operating systems.

A user can enter commands and information into the computer 1100 through one or more wired/wireless input devices, e.g., a keyboard 1138 and a pointing device, such as a mouse 1140. Other input devices (not shown) may include a microphone, an IR remote control, a joystick, a game pad, a stylus pen, touch screen, or the like. These and other input devices are often connected to the processing unit 1104 through an input device interface 1142 that is coupled to the system bus 1108, but can be connected by other interfaces, such as a parallel port, an IEEE 1394 serial port, a game port, a USB port, an IR interface, etc.

A monitor 1144 or other type of display device is also connected to the system bus 1108 through an interface, such as a video adapter 1146. In addition to the monitor 1144, a computer 1100 typically includes other peripheral output devices (not shown), such as speakers, printers, etc.

The computer 1100 can operate in a networked environment using logical connections by wired and/or wireless communications to one or more remote computers, such as a remote computer(s) 1148. The remote computer(s) 1148 can be a workstation, a server computer, a router, a personal computer, portable computer, microprocessor-based entertainment device, a peer device or other common network node, and typically includes many or all of the elements described relative to the computer, although, for purposes of brevity, only a memory/storage device 1150 is illustrated. The logical connections depicted include wired/wireless connectivity to a local area network (LAN) 1152 and/or larger networks, e.g., a wide area network (WAN) 1154. Such LAN and WAN networking environments are commonplace in offices and companies, and facilitate enterprise-wide computer networks, such as intranets, all of which may connect to a global communications network, e.g., the Internet.

When used in a LAN networking environment, the computer 1100 is connected to the local network 1152 through a wired and/or wireless communication network interface or adapter 1156. The adapter 1156 may facilitate wired or wireless communication to the LAN 1152, which may also include a wireless access point disposed thereon for communicating with the wireless adapter 1156.

When used in a WAN networking environment, the computer 1100 can include a modem 1158, or is connected to a communications server on the WAN 1154, or has other means for establishing communications over the WAN 1154, such as by way of the Internet. The modem 1158, which can be internal or external and a wired or wireless device, is connected to the system bus 1108 through the input device interface 1142. In a networked environment, program modules depicted relative to the computer, or portions thereof, can be stored in the remote memory/storage device 1150. It will be appreciated that the network connections shown are exemplary and other means of establishing a communications link between the computers can be used.

The computer is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE802.11 (a, b, g, n, etc.) to provide secure, reliable, fast wireless connectivity. A Wi-Fi network can be used to connect computers to each other, to the Internet, and to wired networks (which use IEEE802.3 or Ethernet). Wi-Fi networks operate in the unlicensed 2.4 and 8 GHz radio bands, at an 11 Mbps (802.11b) or 84 Mbps (802.11a) data rate, for example, or with products that contain both bands (dual band), so the networks can provide real-world performance similar to the basic “10BaseT” wired Ethernet networks used in many offices.

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Processors can exploit nano-scale architectures such as, but not limited to, molecular and quantum-dot based transistors, switches and gates, in order to optimize space usage or enhance performance of user equipment. A processor also can be implemented as a combination of computing processing units.

In the subject specification, terms such as “store,” “data store,” “data storage,” “database,” “repository,” “queue”, and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory. In addition, memory components or memory elements can be removable or stationary. Moreover, memory can be internal or external to a device or component, or removable or stationary. Memory can comprise various types of media that are readable by a computer, such as hard-disc drives, zip drives, magnetic cassettes, flash memory cards or other types of memory cards, cartridges, or the like.

By way of illustration, and not limitation, nonvolatile memory can comprise read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated example aspects of the embodiments. In this regard, it will also be recognized that the embodiments comprise a system as well as a computer-readable medium having computer-executable instructions for performing the acts and/or events of the various methods.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data, or unstructured data.

Computer-readable storage media can include, but are not limited to, random access memory (RAM), read only memory (ROM), electrically erasable programmable read only memory (EEPROM), flash memory or other memory technology, solid state drive (SSD) or other solid-state storage technology, compact disk read only memory (CD ROM), digital versatile disk (DVD), Blu-ray disc or other optical disk storage, magnetic cassettes, magnetic tape, magnetic disk storage or other magnetic storage devices or other tangible and/or non-transitory media which can be used to store desired information.

In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se. Computer-readable storage media can be accessed by one or more local or remote computing devices, e.g., via access requests, queries or other data retrieval protocols, for a variety of operations with respect to the information stored by the medium.

On the other hand, communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communications media comprise wired media, such as a wired network or direct-wired connection, and wireless media such as acoustic, RF, infrared and other wireless media

Further, terms like “user equipment,” “user device,” “mobile device,” “mobile,” station,” “access terminal,” “terminal,” “handset,” and similar terminology, generally refer to a wireless device utilized by a subscriber or user of a wireless communication network or service to receive or convey data, control, voice, video, sound, gaming, or substantially any data-stream or signaling-stream. The foregoing terms are utilized interchangeably in the subject specification and related drawings. Likewise, the terms “access point,” “node B,” “base station,” “evolved Node B,” “cell,” “cell site,” and the like, can be utilized interchangeably in the subject application, and refer to a wireless network component or appliance that serves and receives data, control, voice, video, sound, gaming, or substantially any data-stream or signaling-stream from a set of subscriber stations. Data and signaling streams can be packetized or frame-based flows. It is noted that in the subject specification and drawings, context or explicit distinction provides differentiation with respect to access points or base stations that serve and receive data from a mobile device in an outdoor environment, and access points or base stations that operate in a confined, primarily indoor environment overlaid in an outdoor coverage area. Data and signaling streams can be packetized or frame-based flows.

Furthermore, the terms “user,” “subscriber,” “customer,” “consumer,” and the like are employed interchangeably throughout the subject specification, unless context warrants particular distinction(s) among the terms. It should be appreciated that such terms can refer to human entities, associated devices, or automated components supported through artificial intelligence (e.g., a capacity to make inference based on complex mathematical formalisms) which can provide simulated vision, sound recognition and so forth. In addition, the terms “wireless network” and “network” are used interchangeable in the subject application, when context wherein the term is utilized warrants distinction for clarity purposes such distinction is made explicit.

Moreover, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

In addition, while a particular feature may have been disclosed with respect to only one of several implementations, such feature may be combined with one or more other features of the other implementations as may be desired and advantageous for any given or particular application. Furthermore, to the extent that the terms “includes” and “including” and variants thereof are used in either the detailed description or the claims, these terms are intended to be inclusive in a manner similar to the term “comprising.”

The above descriptions of various embodiments of the subject disclosure and corresponding figures and what is described in the Abstract, are described herein for illustrative purposes, and are not intended to be exhaustive or to limit the disclosed embodiments to the precise forms disclosed. It is to be understood that one of ordinary skill in the art may recognize that other embodiments having modifications, permutations, combinations, and additions can be implemented for performing the same, similar, alternative, or substitute functions of the disclosed subject matter, and are therefore considered within the scope of this disclosure. Therefore, the disclosed subject matter should not be limited to any single embodiment described herein, but rather should be construed in breadth and scope in accordance with the claims below.

What is claimed is:

1. A system, comprising:
a local manager device that serves a local radio access network area comprising the local manager device and a user equipment, the local manager device comprising:
a processor; and
a memory that stores executable instructions that, when executed by the processor, facilitate performance of operations, the operations comprising:
operating the local manager device to provide local breakout service to the user equipment, comprising,
receiving internet protocol packet data via a sidelink channel from the user equipment, and
communicating the internet protocol packet data to a user plane function.

2. The system of claim 1, wherein the operations further comprise allocating an internet protocol address to the user equipment, and associating the internet protocol address with the sidelink channel.

3. The system of claim 1, wherein the user plane function is incorporated into the local manager device, wherein the user equipment is a first user equipment, wherein the sidelink channel is a first sidelink channel, and wherein the operations further comprise facilitating routing the internet protocol packet data from the user plane function to a second user equipment over a second sidelink channel.

4. The system of claim 3, wherein the operations further comprise maintaining a routing data structure that maps allocated internet protocol addresses to respective user equipment sidelink channels, and accessing the routing data structure based on internet protocol information associated with the internet protocol packet data to determine the second sidelink channel.

5. The system of claim 1, wherein the user plane function is incorporated into the local manager device, wherein the user equipment is a first user equipment, wherein the sidelink channel is a first sidelink channel, and wherein the operations further comprise multicasting the internet protocol packet data from the user plane function to a second user equipment via a second sidelink channel and to a third user equipment via a third sidelink channel.

6. The system of claim 1, wherein the local breakout service comprises a first local breakout service for packet routing, and wherein the operations further comprise providing a second local breakout service, comprising hosting a local virtual application server to provide an application layer local breakout service as the second local breakout service.

7. The system of claim 1, wherein the user equipment comprises a private access user equipment, wherein the user plane function is a private user plane function incorporated into a local private network comprising a locally hosted donor distributed unit communicatively coupled via private user plane traffic to a centralized unit and the private user plane function, and wherein the operating the local manager device to provide the local breakout service to the user equipment comprises operating the local manager device as an intermediate node to communicate the internet protocol data packet from the private access user equipment to the private user plane function.

8. The system of claim 7, wherein the internet protocol packet data comprises a first internet protocol packet data, wherein the local private network hosts an application server, and wherein the operations further comprise, communicating a second internet protocol packet data from the application server to the user equipment.

9. The system of claim 7, wherein the local manager device is communicatively coupled to the private user plane function via a private donor distributed unit and a private centralized unit.

10. The system of claim 7, wherein the local manager device is communicatively coupled to the private user plane function via an internet access and backhaul node.

11. A method, comprising:
receiving, by a local manager device that serves a local radio access network area, an internet protocol data packet via a first sidelink channel from a first user equipment that is served by the local manager device in the local radio access network area, wherein the local manager device comprises a processor; and
routing, by the local manager device via a second sidelink channel, the internet protocol data packet to a second user equipment that is served by the local manager device in the local radio access network area.

12. The method of claim 11, wherein the local manager device performs the routing via a user plane function in the local manager device.

13. The method of claim 11, further comprising, allocating, by the local manager device, a first internet protocol address to the first user equipment, and allocating, by the local manager device, a second internet protocol address to the second user equipment.

14. The method of claim 11, further comprising maintaining, by the local manager device, a first mapping from a first internet protocol address to the first sidelink channel, and maintaining, by the local manager device, a second mapping from a second internet protocol address to the second sidelink channel.

15. The method of claim 11, further comprising, routing, by the local manager device via a third sidelink channel, the internet protocol data packet to a third user equipment that is served by the local manager device in the local radio access network area.

16. The method of claim 11, further comprising hosting, by the local manager device, a local virtual application server that provides an application layer local breakout service to the first user equipment via the first sidelink channel.

17. A machine-readable storage medium, comprising executable instructions that, when executed by a processor of a local manager device in a wireless network, facilitate performance of operations, the operations comprising:
communicating information between a private user plane function of a local private network and a user equipment served by the local manager device, comprising,
receiving a first internet protocol data packet from the user equipment via a sidelink interface,
sending the first internet protocol data packet to the private user plane function,
receiving a second internet protocol data packet from the private user plane function, and
sending the second internet protocol data packet to the user equipment via the sidelink interface.

18. The machine-readable storage medium of claim 17, wherein the sending the first internet protocol data packet to the private user plane function comprises transmitting the first internet protocol data packet via a private distributed unit coupled to a private centralized unit to the private user plane function.

19. The machine-readable storage medium of claim 18, wherein the operations further comprise, associating the local manager device with an integrated access and backhaul node that is communicatively coupled to the private distributed unit.

20. The machine-readable storage medium of claim 17, wherein the private network hosts an application server, and wherein the operations further comprise, receiving a third internet protocol data packet from the application server, and sending the third internet protocol data packet to the user equipment via the sidelink interface.
